(19) United States
(12) Patent Application Publication
(10) Pub. No.: US 2010/0316196 A1
(43) Pub. Date: Dec. 16, 2010

(54) METHOD AND SYSTEM FOR WARNING A PARTY PROVIDED WITH A TERMINAL

(76) Inventor: Tapio Jokinen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/735,327

(22) PCT Filed: Jan. 2, 2009
(86) PCT No.: PCT/FI2009/050002

§ 371 Date: Aug. 23, 2010

(30) Foreign Application Priority Data
Jan. 4, 2008 (FI) 20080003

(51) Int. Cl. H04M 11/04; G08B 23/00; H04W 4/22

(52) U.S. Cl. 379/38; 340/573.1; 455/404.2

(57) ABSTRACT

A system for warning a party provided with a terminal comprises databases of profile information of the party, environment information of a geographical location, and location information of the terminal. The system is adapted to, based on location information of the terminal, to check whether the terminal locates within the geographical location, and if yes, to analyse profile information of the party so that if profile information comprises a parameter which matches with a corresponding parameter of environment information of a geographical location, a warning message is sent to the terminal in order to warn the party.

### TECHNICAL FIELD OF THE INVENTION

The invention relates to a method and system for warning a party provided with a terminal. In addition the invention relates to a corresponding computer program product.

### BACKGROUND OF THE INVENTION

Different kind of diseases, an outbreak of disease, or expository disease and allergies are inconvenient events. Moreover diseases incur huge financial loss and numbers of day of illness. Many diseases or symptoms are incurred or worsen by environment events, such as weather or changes in weather, like a heat wave, pollen, air impurity, forest fire and its smoke and small particles, as well as dry or hot weather, or other extreme phenomena in weather.

Nowadays weather forecasts are very accurate and weather can be predicted at least roughly for five to ten days or even for longer period in a certain probability. Therefore it is possible to those parties having a certain disease or the like to keep up with the forecast and plan their lives accordingly.

### SUMMARY OF THE INVENTION

An object of the invention is to warn parties about a certain environmental event beforehand in order to alleviate or even prevent possible consequences of said event to said party. Especially an object of the invention is to warn the parties individually by avoiding gratuitous warnings, and thus avoiding also frustration and indifference of the parties.

The object of the invention can be fulfilled by providing a party with a terminal, and gathering profile information of the party, environment information of a geographical location, and location information of the terminal, whereafter based on location information of the terminal it is checked whether the terminal locates within said geographical location, and if yes, profile information of the party is analysed and if profile information comprises a parameter which matches with a corresponding parameter of environment information of a geographical location, a warning message is sent to the terminal in order to warn the party.

According to an embodiment of the invention the party is provided with a mobile terminal, such as a mobile phone, whereupon its location information can be determined based on a cell information in which the mobile phone locates. The cell information can be achieved e.g. from a base station serving the mobile phone at the moment. However, the mobile terminal may also be a laptop computer or other mobile data processing means, which can roam from cell to cell of different base stations, such as in a WLAN data network, and which location can be determined based on the base station serving the mobile terminal on that moment. Location information can be gathered either directly from base stations or asking from the terminal.

However, the terminal may also be a fixed terminal, such as a land lined telephone or desktop computer, which location is fixed and known by the system of the invention.

In order to know when the parties should be warned it is advantageous that each party has an own user profile advantageously in a database of a system, where the user profile comprises information about the party, such as health information or information relating to a medication of the party, age, sex, fitness, and/or size. Health information may be e.g. information about heart disease, allergy, such as pollinosis, asthma, obesity, physical disability, immobility, eye disease, hearing loss, night-blindness, photodermatosis, dry-skinned, renal failure, and/or pregnancy. The gathered accurate profile information of the party ensures that the party is warned only when there is a certain event, which relates at least somehow to the party, and by this way gratuitous warnings can be avoided.

In addition, according to an embodiment of the invention, profile information of the party may also comprise information about probable location of the party in a certain moment. This information can be gathered e.g. by following the movements of the party and by analysing location versus time information and especially regularity of the movements of the party. For example it can be detected that the party leaves every weekday a certain location (e.g. home) in the morning at 7:00, moves a certain route and arrives to a certain location (e.g. work) at 7:15, and again in the evening leaves the location at 16:00, moves the same route but reversed direction and arrives the first location (e.g. home) at 16:30. Again it can be detected e.g. that every Wednesday evening the party moves a certain route between 18:00 and 21:00, and every weekend another route starting at 18:00 on Friday and the same route in reversed direction on Sunday at 15:00. Often it is sufficient to determine routes the party uses typically, without any special time information, namely most people typically uses only few routes, whereupon rarely used routes can be ignored.

Location information can also be gathered e.g. by gathering location data from the base stations which serve the mobile terminal, such as a mobile phone, when the party moves with the mobile terminal in the coverage area of different base stations and cells.

According to an embodiment of the invention the party may also input location information to the database of the system manually as such, like home (Helsinki), cottage (Lappeenranta), college (Amsterdam), or location information with time information, such as New York (27.5.2008), Sydney (18.7.2008), and Tokyo (20.10.2008-25.10.2008), or routes to used typically on weekdays and/or weekends, for example.

Based on gathered data or input data as illustrated above the location where the party will locate in near future, or where (s)he locates typically, can be predicted in a certain probability. Of course the present location can be known very accurately, because it can be ensured e.g. by asking from a network of the mobile terminal (such as from base stations) or asking it directly from the terminal.

According to an embodiment environment information may comprise information relating to weather or weather forecast, traffic information, natural phenomena and/or certain special information relating a certain location, and especially predictions of certain natural phenomena and/or certain special information relating a certain location. Especially environment information is related to certain geographical locations. Information relating to weather forecast may be e.g. tomorrow hot wave, day after tomorrow very hot and dry, a week hence pollen, or tomorrow freezing rain, icy and windy. Traffic information may be information relating to traffic jams or accidents with location information, for example. Natural phenomena information may be information relating to a forest fire and combustion gas, for example.

Now, according to an embodiment of the invention the party being in a certain location and suffering e.g. a hay fever can be warned for example when the weather forecast predicts increasing pollen count in that area. According to another embodiment of the invention the location of the party can be predicted, as depicted above, and now if the weather forecast predicts increasing pollen count in a location within time limit when the party will be at the same location, the party can be warned beforehand so that (s)he can be prepared e.g. with suitable medicines or even keeping away that location on that time.

Furthermore, a warning message may also comprise a question for a party, to which the party should also answer. For example, if the party has a renal failure and needs to use an apparatus for dialysis e.g. once a week and it is noticed that e.g. a snowstorm is predicted to a location of the party, (s)he is advantageously warned about the event by a warning message having a question about whether the party is able to leave the place or not before the snowstorm, or does the party have medicines. If the party is not able to leave the place, it may incur some additional tasks, such as informing a corresponding medical staff. This kind of warning is called a dynamic warning, and it can also comprise individualized instructions, such as leaving the place within two days, or get some medicine before the event.

The exemplary embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

In addition, even though it is explained in this document that the warning message is sent to the terminal in order to warn the party, it is only a non limiting example and according to another embodiment of the invention the dynamic warning message sent may also comprise a query to which the user or user's terminal must send an answer. By the query additional information e.g. relating to a situation, such as sufficiency of medicine or state of the user, can be gathered, and more accurate instructions or warning can be produced either to the user or other parties. It should be noted that number of additional questions may be sent to the user's terminal based on the gathered answer and/or other information relating to the environment for example.

For example a query can be sent to the user's terminal and displayed to the user to answer to the query. Based on the user's answer an operation can be performed, such as informing a third party, like a medical staff. Also more detailed instructions or warnings can be sent and dispalyed to the user via his terminal.

### BRIEF DESCRIPTION OF THE DRAWINGS

Next the invention will be described in greater detail with reference to exemplary embodiments in accordance with the accompanying drawings, in which

FIG. 1 illustrates an exemplary warning system according to an advantageous embodiment of the invention, and

FIG. 2 illustrates an exemplary warning method according to an advantageous embodiment of the invention.

### DETAILED DESCRIPTION

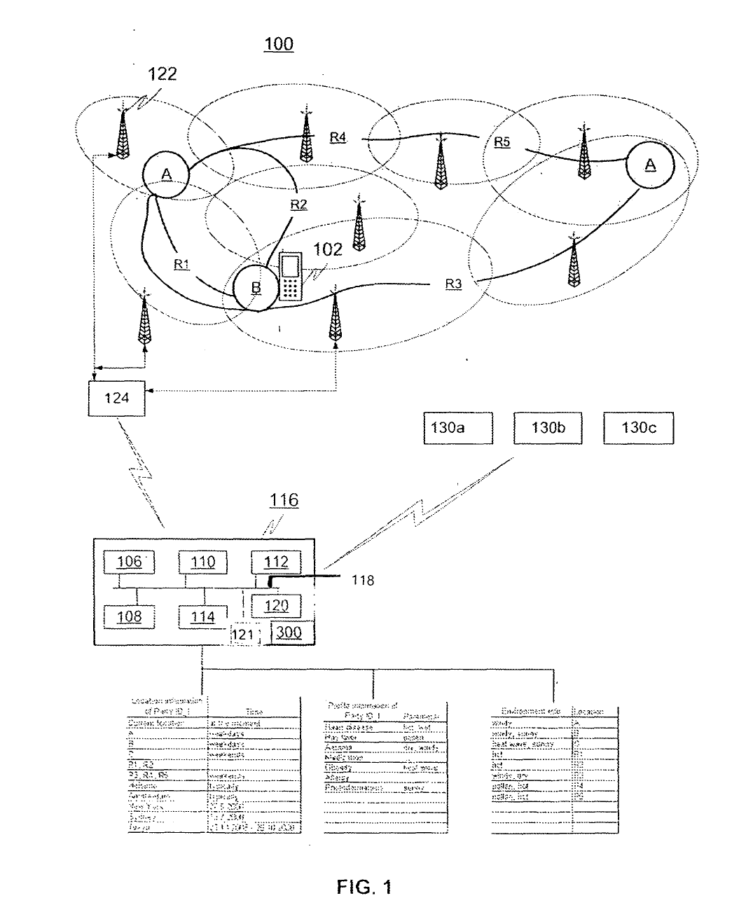

FIG. 1 illustrates an exemplary warning system 100 according to an advantageous embodiment of the invention, where a party, who lives in A, is at work in B and travels in weekends to C, is provided with a mobile terminal 102. The system comprises advantageously a database 104a of profile information of the party, a database 104b of location information of the party or terminal, a database 104c of environment information of different geographical locations.

The system comprises also means 106 for checking based on using information of database 104, whether the terminal locates within said geographical location, or even whether said terminal will locate in a certain location in near future in a certain probability or at least typically. In addition the system comprises means 108 for analysing profile information of the party based on information of database 104a and also analysing, whether profile information comprises a parameter which matches with a corresponding parameter of environment information of a geographical location. If there is a matching parameter, the warning system sends a warning message to said terminal using means 110 in order to warn the party.

According to an embodiment the system comprises means 112 of gathering location information of the terminal by enquiring base stations 122 (or other means 124) of the network serving said terminal. In data connection with gathering means are also prediction means 114 for determining most probable routes and locations where the party typically travels or is, or even where the party will be in near future in a certain probability. Furthermore gathering means 112 is typically in a data connection with certain services offering information, such as weather service 130a, traffic service centre 130b, and other service centres 130c offering information for example of natural phenomena and/or certain special information relating a certain location.

Means 106-114 are in an embodiment implemented by a server 116, which can be a computer for example, having a data bus 118 connection means 106-114 to each other in an appropriate way, such as a data processing means 120 for controlling the data flow in the data bus, as well as controlling the functioning of means 106-114. In addition, the databases 104a-c may be implemented outside and independently of the server, but in an advantageous embodiment the databases 104a-c are implemented by the server.

As an example, the party in FIG. 1 has a hay fever, as can be seen from his profile information database 104a. In addition, he typically moves between points A and B via routes R1 or R2, mostly via R1. Furthermore he travels also between points A and C, or B and C, mostly between A and B via routes R4 and R4, but sometimes also via route R3. Information relating to these routes and locations are stored in the location information database 104b, as can be seen from FIG. 1.

In addition, as an example, the gathering means 112 has gathered weather information from the weather service 130a and stored gathered weather information to the database 104c of environment information with corresponding location data, meaning that for example a heat wave is forecast in location C, and increasing pollen count to locations, which match with the routes R4 and R5.

Now, the analysing means 108 is adapted to analyse and compare data above and when predicted location of the party (route R4 and R5) match with location data with forecast increasing pollen count and in addition the party has a hay fever, a warning message is advantageously sent to the party by means 110. The warning message may be for example only a notification about the event, but also more detailed information about duration and seriousness of the event. In addition the warning message may also comprise advisory information (even individualized information), such as proposing another route or suggesting to take appropriate medicaments, or in addition the warning message may comprise also a question.

The system is advantageously adapted to warn the party for example few days before the event, when the weather service for example (or other environment data service) outputs reliable forecast information about possible weather event in near future.

It should be noted that in an embodiment of the invention the functions of the above mentioned means 106-114 in the server may be implemented at least partly with a computer program product 300 loadable into the internal memory of the computer 116, where said computer program product advantageously comprises software code portions for performing the functions of the above mentioned means. The computer program product 300 may also be stored on a computer usable medium.

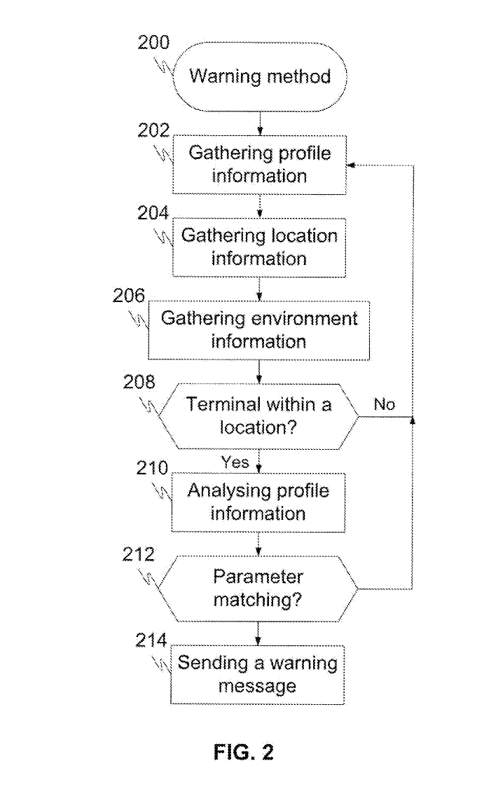

FIG. 2 illustrates an exemplary warning method 200 according to an advantageous embodiment of the invention, where at step 202 profile information of the party is gathered, such is disclosed elsewhere in this document. In addition environment information of geographical locations is gathered at step 204, and location information of the terminal (or party) is gathered of step 206. Step 206 may also comprise a sub-step of making predictions about the locations, where the party will be in a certain moment in a certain probability.

The performing of above mentioned steps are not one-time performance, but a continuous, repetitive process.

At step 208 it is checked based on location information of the terminal, whether the terminal locates (or will locate) within the geographical location of at least one event. If it seems that party locates or will locate in that area, party's profile information is analysed at step 210 and determined at step 212, whether profile information comprises a parameter which matches with a corresponding parameter of environment information of said geographical location. If yes, warning message is send to the party's terminal at step 214 in order to warn the party.

If the party is not located or it is not probably that the party will locates in that environment (at step 208) or if none of the parameter in the party's profile information matches with the corresponding parameter of environment information of said geographical location (at step 212), the method is continued for example in step 202 or 208 again.

In connection with the method 200 it should be noted that the order of the steps could also be different than depicted in this example. Especially information can be gathered in different order and continuously. Furthermore in an embodiment data can also be analysed in different order, such as at first checking possible matching with profile information and environment information (step 210 in FIG. 2) and after this checking location information, if there exist any matches (step 208 in FIG. 2).

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

What is claimed is:

1. A warning system for warning a party provided with a terminal, wherein the system is provided with profile information of the party, the profile information comprising health information and information relating to a medication of the party being conditional on environments and/or weather conditions, environment and/or weather information of a geographical location, and location information of the terminal, and wherein the warning system comprises at least one processor and at least one memory including computer program code, the at least one memory and the computer program code configured to, with the at least one processor, cause the warning system at least to perform
is checking based on location information of the terminal, whether the terminal locates within said geographical location, and if yes,
analysing profile information of the party and if profile information comprises a parameter of said health information and/or information relating to a medication of the party which matching with a corresponding parameter of environment and/or weather information of said geographical location, sending a dynamic warning message comprising a question to be answered to said terminal, and based on the answer performing at least one additional task of: informing a third party, providing instructions to be displayed on the terminal, and warning the party via said terminal.

2. The warning system according to claim 1, wherein said terminal is a mobile terminal, such as a mobile phone, and its location information is determined based on a base station serving said terminal, or said terminal is a fixed terminal, such as a land lined telephone.

3. The warning system according to claim 1, wherein profile information of the party comprises information relating to a health status of the party, and/or information of probable location of the party in a certain moment of time based on gathered location versus time information of the party in the past.

4. The warning system according to claim 1, wherein environment information of the geographical location comprises information relating to weather, traffic information, natural phenomena and/or certain special information relating a certain location.

5. The warning system according to claim 3, wherein the system is configured to perform: predicting the location where the party will locate in the near future in a certain probability based on gathered data and in addition, using this predicted location information as location information of the terminal when checking whether said terminal locates within said geographical location.

6. A warning method for warning a party provided with a terminal, wherein profile information of the party comprising health information and information relating to a medication of the party being conditional on environments and/or weather conditions, environment and/or weather information of a geographical location, and location information of the terminal is gathered, the warning method comprising
checking based on location information of the terminal, whether the terminal locates within said geographical location, and if yes,
analysing profile information of the party and if profile information comprises a parameter of said health information and/or information relating to a medication of the party which matches with a corresponding parameter of environment and/or weather information of said geographical location, sending a dynamic warning message comprising a question to be answered to said terminal, and based on the answer performing at least one additional task of: informing third party, providing instructions to be displayed on the terminal, and warn the party via said terminal.

7. The warning method according to claim 6, wherein said terminal is a mobile terminal, such as a mobile phone, and its location information is determined based on a base station serving said terminal, or said terminal is a fixed terminal, such as a land lined telephone.

8. The warning method according to claim 6, wherein profile information of the party comprises information relating to a health status of the party, and/or information of probable location of the party in a certain moment of time based on gathered location versus time information of the party in the past.

9. The warning method according to claim 6, wherein environment information of the geographical location comprises information relating to weather, traffic information, natural phenomena and/or certain special information relating a certain location.

10. The warning method according to claim 8, wherein the location where the party will locate in the near future in a certain probability is predicted based on gathered data and in addition this predicted location information is used as location information of the terminal when checking whether said terminal locates within said geographical location.

11. A computer program product directly loadable into the internal memory of a digital computer, said computer program product comprising software code portions for performing the steps of claim 6 when said product is run on a computer.

12. A computer program product stored on a computer usable medium comprising computer readable program means for causing a computer to perform the steps of claim 6 when said product is run on a computer.
